(19) United States
(12) Patent Application Publication
(10) Pub. No.: US 2012/0249271 A1
(43) Pub. Date: Oct. 4, 2012

(54) ELECTROMAGNETIC CONTACTOR UNIT

(75) Inventors: Yasuhiro Naka, Kounosu-city (JP); Koji Okubo, Kounosu-city (JP); Kouetsu Takaya, Kounosu-city (JP); Kenji Suzuki, Kounosu-city (JP)

(73) Assignee: FUJI ELECTRIC FA COMPONENTS & SYSTEMS CO., LTD., Chuo-ku, Tokyo (JP)

(21) Appl. No.: 13/500,407

(22) PCT Filed: Sep. 13, 2010
(86) PCT No.: PCT/JP2010/005585

§ 371 Date: Jun. 4, 2012

(30) Foreign Application Priority Data
Jan. 27, 2010 (JP) 2010-015215

(51) Int. Cl. H01H 45/04

(52) U.S. Cl. 335/202

(57) ABSTRACT

There is provided an electromagnetic contactor unit capable of firmly connecting electromagnetic contactors without influencing outer dimensions when the electromagnetic contactors are connected to each other. The electromagnetic contactor unit connected at least two juxtaposed electromagnetic contactors (2a, 2b) with a connection piece (42). The electromagnetic contactor includes an attachment hole (41a) formed in each corner of an attachment plate portion, a piece accommodation concave portion (43) fitting a half portion of the connection piece formed above the attachment hole and accommodating within an outer dimension, and is opened to a connection surface with the adjacent electromagnetic contactor, and a locking portion (44) locking the connection piece formed in the piece accommodation concave portion. The connection piece includes a pair of engagement protrusions (42b, 42c) which are individually engaged with the adjacent attachment holes of the juxtaposed electromagnetic contactors, and a locked portion (42k) locked by the locking portion.

### TECHNICAL FIELD

The present invention relates to an electromagnetic contactor unit wherein a plurality of electromagnetic contactors is connected.

### BACKGROUND ART

As a unit for connecting electromagnetic contactors to each other, a switch unit described in Patent Document 1 is known. In the switch unit, by fitting a connection changeover portion in slits in connection-side side surfaces of two juxtaposed switches, when one of the switches is brought into a turned-on state, the transition of the other switch to the turned-on state is prevented. In addition, there are provided E-shaped clamps each of which has a central shaft and a pair of leg portions sandwiching the central shaft, and there are formed ribs having concave portions in opposing surfaces formed at end portions of the connection-side side surfaces of the two switches. Each of the clamps is attached from the outside such that the central shaft is fitted in the concave portion and the leg portions hold the rib between them from a side opposite to the side of the concave portion of the rib, and the two switches are thereby integrated.
Patent Document 1: Japanese Translation of PCT Application No. 2000-502208

### DISCLOSURE OF THE INVENTION

However, in the conventional art described in Patent Document 1 described above, in order to integrate the juxtaposed switches, the clamps are attached to the ribs having the concave portions formed in the connection-side side surfaces of the switches from the outside. Accordingly, in a state where the clamps are attached to the switches, the clamps protrude to the outside of the switches, and there arises an unsolved problem that the outer dimensions of the combined switches are increased.

In view of the foregoing, the present invention has been achieved by focusing on the unsolved problem of the conventional art described above, and an object thereof is to provide an electromagnetic contactor unit capable of firmly connecting electromagnetic contactors without influencing outer dimensions when the electromagnetic contactors are connected to each other.

In order to achieve the above-described object, an electromagnetic contactor unit according to an embodiment of the present invention is connected at least two juxtaposed electromagnetic contactors with a connection piece. Each of the electromagnetic contactors includes an attachment hole which is formed in each corner of an attachment plate portion, a piece accommodation concave portion fitting a half portion of the connection piece formed above the attachment hole and accommodating within an outer dimension, and is opened in a connection surface with the adjacent electromagnetic contactor, and a locking portion locking the connection piece formed in the piece accommodation concave portion. In addition, the connection piece includes a pair of engagement protrusions individually engaged with the adjacent attachment holes of the juxtaposed electromagnetic contactors, and a locked portion locked by the locking portion.

According to the structure, by attaching the connection piece in the piece accommodation concave portions of the juxtaposed electromagnetic contactors, the electromagnetic contactors are integrated. At this point, the connection piece fits within the outer dimensions of the electromagnetic contactor, and hence the outer dimensions of the connected electromagnetic contactors are not increased. In addition, since the pair of engagement protrusions of the connection piece is engaged with the attachment holes formed in the attachment plate portions of the electromagnetic contactors, and the locked portion is locked by the locking portion formed in the piece accommodation concave portion, even when an external force which displaces the connected electromagnetic contactors in mutually opposite directions is applied to the electromagnetic contactors in any direction, it is possible to prevent the displacement between the electromagnetic contactors.

In the electromagnetic contactor unit according to another aspect of the present invention, the connection piece at least includes an attachment plate portion formed with the pair of engagement protrusions on one surface, a pair of side plate portions formed on the other surface of the attachment plate portion, a front plate portion connecting attachment plate portion sides of the pair of side plate portions, and a curve portion curved from a tip of the front plate portion to the rearward side and has the locked portion formed to protrude at its tip.

According to the structure, since the curve portion can secure elasticity, and the curve portion is formed with the locked portion protruding toward the side opposite to the side of the engagement protrusion at its tip, by causing the locked portion to be locked by the locking portion formed in the piece accommodation concave portion of the electromagnetic contactor, the movement of the connection piece from the piece accommodation concave portion to the side opposite to the side of the engagement protrusion is regulated.

Also, in the electromagnetic contactor unit according to another aspect of the present invention, the piece accommodation concave portion is formed of a concave portion which allows a tool for tightening a screw inserted into the attachment hole to be inserted thereinto.

According to the structure, since the concave portion is formed for allowing an insertion of a tool for tightening the screw inserted into the attachment hole when the electromagnetic contactor is attached to a base or the like such as a driver or the like, it is not necessary to newly form space for accommodating the connection piece.

In the electromagnetic contactor unit according to yet another aspect of the present invention, a holding protrusion formed between the pair of engagement protrusions of the connection piece is inserted between the adjacent electromagnetic contactors and serves as a holding portion by cooperating with the pair of engagement protrusions.

According to the structure, it is possible to hold portions between the connection surfaces and the attachment holes of the attachment plate portions of the electromagnetic contactors between the engagement protrusions and the holding protrusion of the connection piece, and thereby connect the electromagnetic contactors to each other more firmly.

Also, in the electromagnetic contactor unit according to another aspect of the present invention, each of the pair of engagement protrusions is formed into a C-shaped tubular shape formed by notching a cylindrical portion thereof on a side of a contact surface with the piece accommodation portion, and having a tapered portion formed on an outer peripheral surface of a tip side thereof.

According to the structure, since the engagement protrusion is formed into the C-shaped tubular shape, it becomes possible to bend the engagement protrusion when the engagement protrusion is inserted into the attachment hole of the electromagnetic contactor so that the engagement with the attachment hole is facilitated, and since the tapered portion is formed at the tip, the engagement with the attachment hole is further facilitated.

According to the present invention, when electromagnetic contactors are juxtaposed and connected, piece accommodation concave portions are formed in the electromagnetic contactors, a connection piece is accommodated in the piece accommodation concave portions on connection surface sides of the electromagnetic contactors to be connected, a pair of engagement protrusions of the connection piece is engaged with adjacent attachment holes of the electromagnetic contactors, and locked portions are locked by locking portions formed in the piece accommodation concave portions, whereby it is possible to firmly connect the electromagnetic contactors to each other without causing the connection piece to protrude from a range of outer dimensions of the electromagnetic contactors.

### BRIEF DESCRIPTION OF THE DRAWINGS

FIG. 1 is a perspective view showing an electromagnetic contactor unit according to the present invention;

FIG. 2 is an exploded perspective view of the electromagnetic contactor unit of FIG. 1;

FIG. 3 is a cross-sectional view showing an electromagnetic contactor;

FIGS. 4(a) to 4(c) are plan views for explaining an operation of a reversible unit, wherein FIG. 4(a) shows a release state, FIG. 4(b) shows a left-side turned-on state, and FIG. 4(c) shows a right-side turned-on state;

FIG. 5 is a perspective view showing the reversible unit and the electromagnetic contactors before attachment;

FIG. 6 is a perspective view showing a lower frame of the electromagnetic contactor;

FIGS. 7(a) and 7(b) are perspective views showing a connection piece, wherein FIG. 7(a) is a perspective view on the front side and FIG. 7(b) is a perspective view on the back side;

FIG. 8 is a plan view showing a cross section of a principal portion in a state where the electromagnetic contactors are connected using the connection piece; and

FIG. 9 is a side view showing a cross section of a principal portion in the state where the electromagnetic contactors are connected using the connection piece.

### BEST MODE FOR CARRYING OUT THE INVENTION

A description is given hereinbelow of an embodiment of the present invention with reference to the drawings.

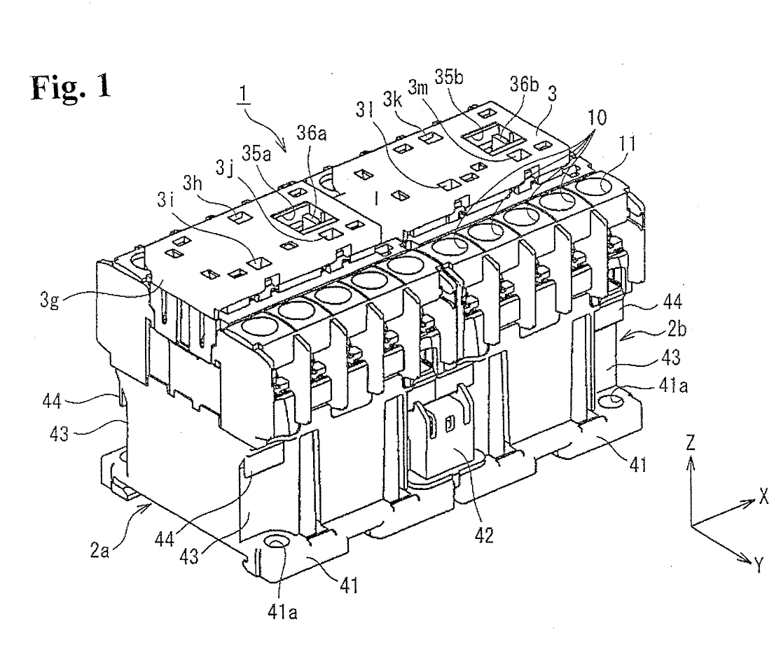

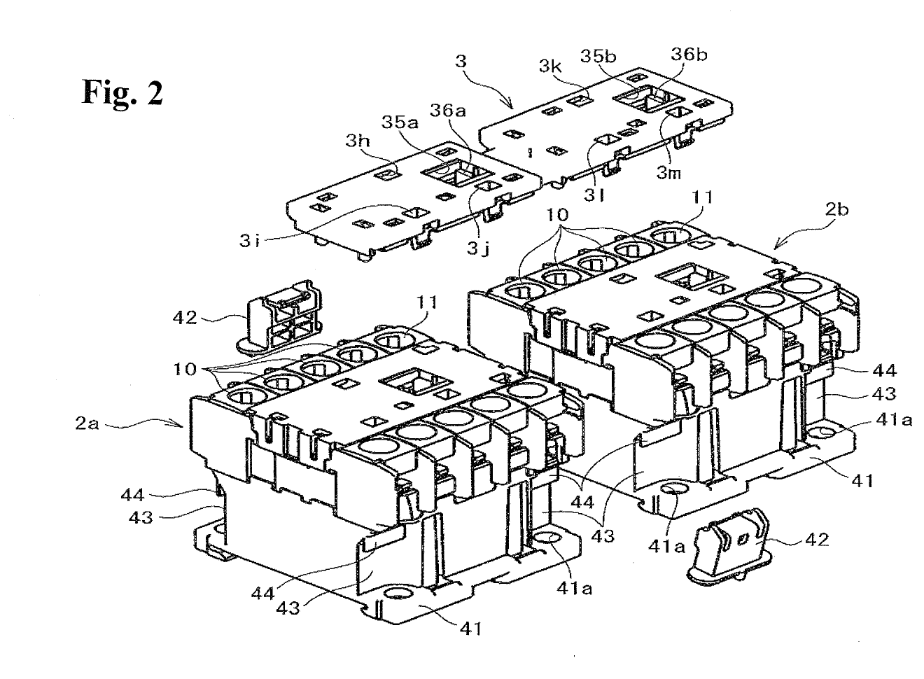

FIG. 1 is a perspective view showing an electromagnetic contactor unit which is connected to a feeder circuit of, e.g., a three-phase induction motor (not shown), and controls a forward/reverse operation of the induction motor, while FIG. 2 is a developed perspective view of FIG. 1.

An electromagnetic contactor unit 1 comprises two electromagnetic contactors 2a and 2b and one reversible unit 3.

One electromagnetic contactor 2a of the two electromagnetic contactors 2a and 2b is an electromagnetic contactor which controls a forward rotation of the induction motor, while the other electromagnetic contactor 2b is an electromagnetic contactor which controls a reverse rotation of the induction motor.

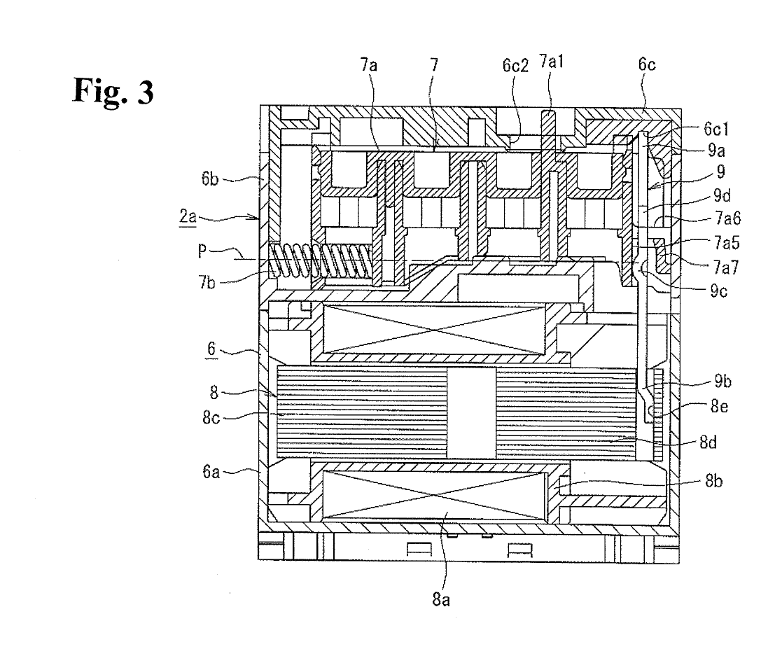

As shown in FIG. 2, the electromagnetic contactor 2a is a device which includes terminal portions 10 each having a contact and a coil terminal portion 11 on its upper surface and, as shown in FIG. 3, a contact portion 7, an electromagnet 8, and a drive lever 9 are accommodated in a main body case 6.

The main body case 6 has a lower case 6a which accommodates the electromagnet 8, an upper case 6b which accommodates the contact portion 7, and an arc extinguishing cover 6c which covers the upper portion of the upper case 6b.

The arc extinguishing cover 6c is formed with a rectangular display window 6c2 which communicates with the front and back sides of the arc extinguishing cover 6c, and a movement display piece 7a1 of the contact portion 7 is protruded to the upper surface through the display window 6c2. In addition, in the arc extinguishing cover 6c, connection holes 12 to 14 which allow connection of the one reversible unit 3 are formed to extend through the arc extinguishing cover 6c in a front and back direction. The connection holes 12 to 14 are quadrilateral holes.

As shown in FIG. 3, the contact portion 7 comprises a movable contact support 7a which is disposed in the upper case 6b so as to be slidable in a predetermined direction, and a return spring 7b which presses the movable contact support 7a in one direction.

The electromagnet 8 has an exiting coil 8a wound therearound, and includes a tubular coil frame 8b which has an axial direction set in parallel with a sliding direction of the movable contact support 7a, a fixed core 8c which is inserted into a hollow portion of the coil frame 8b and is fixed on a side wall of the lower case 6a, and a movable core 8d which opposes the fixed core 8c so as to be movable close to or away from the fixed core 8c and is inserted into the hollow portion of the coil frame 8b.

In addition, in order to transmit an attraction movement and a release movement of the movable core 8d to the movable contact support 7a, as shown in FIG. 3, the drive lever 9 connects between the side of the movable contact support 7a opposite to the side of the return spring 7b and the movable core 8d of the electromagnet 8.

The drive lever 9 is a plate-like member, its upper end in a longitudinal direction serves as a rotation shaft portion 9a, the other end side thereof in the longitudinal direction is formed with a movable core connection portion 9b, and the central portion thereof in the longitudinal direction is provided with a movable contact support connection portion 9c. Further, a pair of supported portions 9d is formed at positions closer to the rotation shaft portion 9a than the movable contact support connection portion 9c.

The movable core connection portion 9b of the drive lever 9 is inserted into a connection hole 8e formed in the movable core 8d from above, and is connected to the movable core 8d. In addition, the rotation shaft portion 9a of the drive lever 9 enters into a shaft concave portion 6c1 provided in the lower surface of the arc extinguishing cover 6c and is rotatably connected to the arc extinguishing cover 6c.

Note that the other electromagnetic contactor 2b has the same structure as that of one electromagnetic contactor 2a so that the detailed description thereof is omitted.

The reversible unit 3 disposes the two electromagnetic contactors 2a and 2b so as to be adjacent to each other and fixes them, and serves as an interlock device which mechanically locks the two electromagnetic contactors 2a and 2b so as to prevent the two electromagnetic contactors 2a and 2b from being simultaneously brought into a close (ON) state even when an operation signal is inputted to both of the two electromagnetic contactors 2a and 2b by any operation (even when the electromagnets 8 of the two electromagnetic contactors 2a and 2b simultaneously attempt to operate).

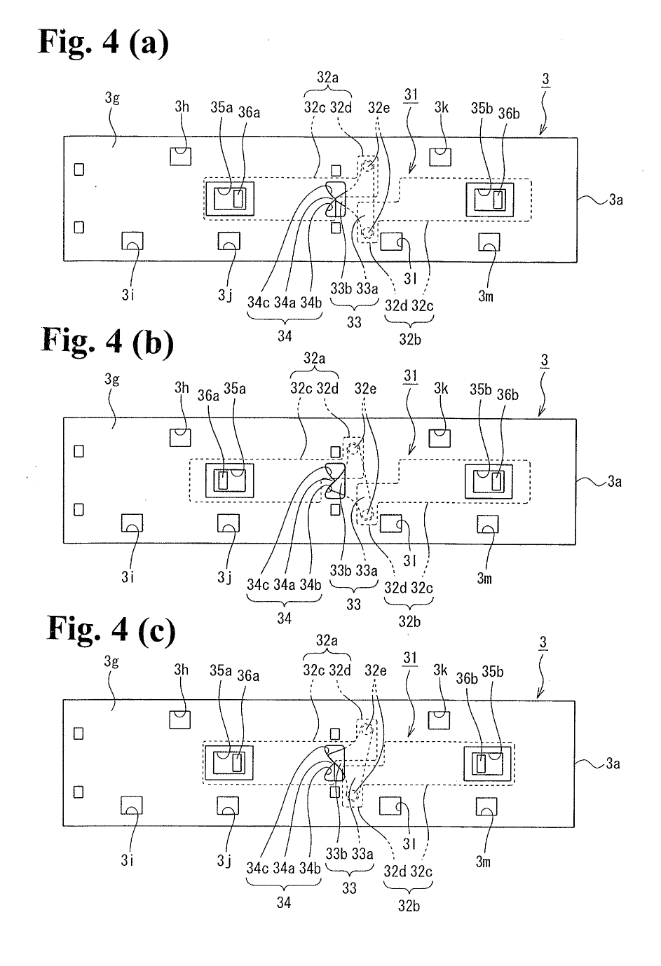

As shown in FIGS. 4(a)-4(c), the reversible unit 3 includes a rectangular parallelepiped unit main body 3a, and snap pieces 3c to 3f each having a claw portion with its tip protruding outward which protrude from a contactor attachment portion 3b on the back surface side of the unit main body 3a which contact with the arc extinguishing covers 6c of the adjacently disposed two electromagnetic contactors 2a and 2b.

In addition, in the reversible unit 3, as shown in FIGS. 1 and 2, there are formed connection holes 3h, 3i, 3j, 3k, 3l, and 3m with which hook pieces of an auxiliary contact unit which is not shown are engaged on the front surface side of the unit main body 3a.

Further, in the unit main body 3a, as shown in FIGS. 4(a)-4(c), there is provided an interlock mechanism 31 which mechanically locks the two electromagnetic contactors 2a and 2b so as to prevent the two electromagnetic contactors 2a and 2b from being simultaneously brought into the close (ON) state. The interlock mechanism 31 comprises slide members 32a and 32b which are individually connected to the movement display pieces 7a1 of the electromagnetic contactors 2a and 2b and slidable in a connecting direction, i.e., a longitudinal direction of the electromagnetic contactors 2a and 2b, a slide regulation member 33 which connects between opposing portions of the slide members 32a and 32b on the side of one of front and back surfaces and regulates the slide of one of the slide members 32a and 32b while allowing the slide of the other, and a rotation regulation member 34 which opposes the slide regulation member 33 and regulates its rotation.

The slide members 32a and 32b are formed into identical shapes which are point-symmetric when viewed two-dimensionally, and each of the slide member 32a and 32b comprises a rectangular plate portion 32c and a hook-like portion 32d which is formed outside the inside end of the rectangular plate portion 32c and is bent outward in a direction orthogonal to a longitudinal direction. In addition, in a release state (unlocked state), as shown in FIG. 4(a), the slide members 32a and 32b are disposed such that their respective hook-like portions 32d oppose each other back to back.

The slide regulation member 33 comprises a base portion 33a which is engaged with engagement pins 32e formed on the sides of the outward ends of the hook-like portions 32d of the slide members 32a and 32b, and a triangular protrusion portion 33b which protrudes from the central portion of the base portion 33a toward the slide member 32a.

The rotation regulation member 34 at least includes, in the unit main body 3a, a top portion 34a which closely opposes the top portion of the triangular protrusion portion 33b of the slide regulation member 33 in the release state, a rotation regulation wall portion 34b which is formed of an arc surface which passes through the top portion 34a and is along the trajectory of the movement of the top portion of the triangular protrusion portion 33b when the slide member 32a is slid from the release state, and a rotation regulation wall portion 34c which is formed of an arc surface which passes through the top portion 34a and is along the trajectory of the movement of the top portion of the triangular protrusion portion 33b when the slide member 32b is slid from the release state.

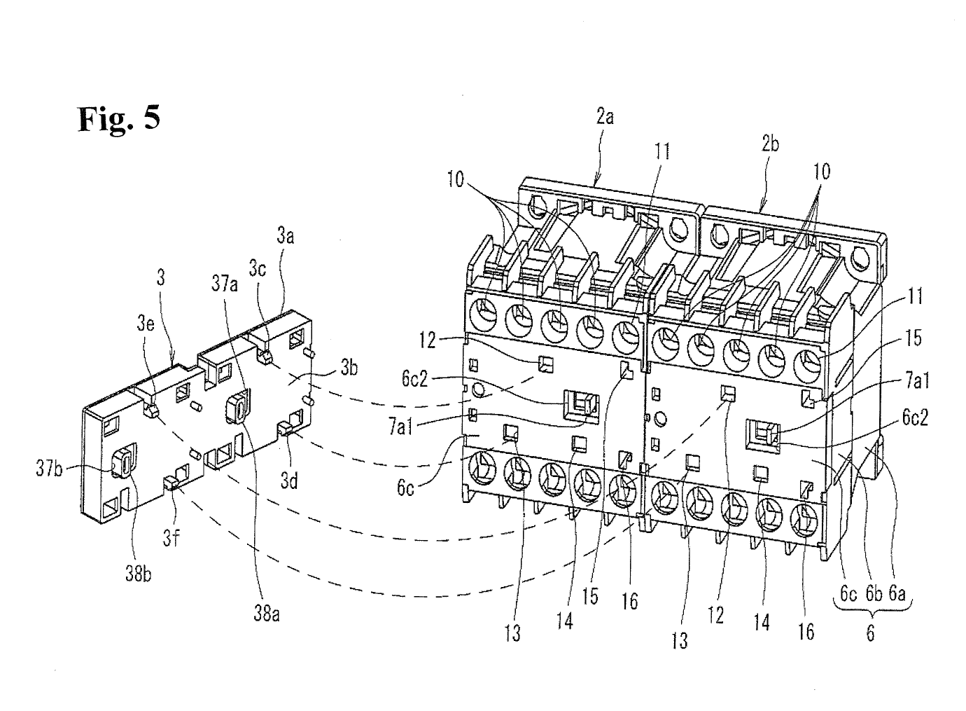

In addition, on the front surface sides of the slide members 32a and 32b, as shown in FIGS. 1 and 2, there are formed movement display pieces 36a and 36b which protrude from rectangular unit windows 35a and 35b formed in the surface of the unit main body 3a. Further, on the back surface sides of the slide members 32a and 32b, as shown in FIG. 5, there are formed tubular display piece engagement portions 38a and 38b which protrude from rectangular unit windows 37a and 37b formed in the back surface of the unit main body 3a.

Furthermore, in a state where each of the above-described electromagnetic contactors 2a and 2b is in an open (OFF) state, the reversible unit 3 is attached onto the electromagnetic contactors 2a and 2b. In the attachment of the reversible unit 3, firstly, while the display piece engagement portions 38a and 38b are engaged with the movement display pieces 7a1 of the electromagnetic contactors 2a and 2b, the tip of the snap piece 3c of the reversible unit 3 is inserted into the connection hole 12 of the electromagnetic contactor 2a and engaged with an opening peripheral edge. Subsequently, the tip of the snap piece 3d is inserted into the connection hole 13 of the electromagnetic contactor 2a and engaged with an opening peripheral edge, the tip of the snap piece 3e is inserted into the connection hole 12 of the electromagnetic contactor 2b and engaged with an opening peripheral edge, the tip of the snap piece 3f is inserted into the connection hole 13 of the electromagnetic contactor 2b and engaged with an opening peripheral edge, and the reversible unit 3 is thereby attached onto the electromagnetic contactors 2a and 2b.

In the state of the attachment of the reversible unit 3, both of the electromagnetic contactors 2a and 2b are in the open (OFF) state. Consequently, as shown in FIG. 4(a), both of the slide members 32a and 32b are at positions to which the slide member 32a and 32b have moved rightward, the interlock mechanism 31 is in the release state, and the base portion 33a of the slide regulation member 33 is oriented in a direction generally orthogonal to the longitudinal direction. Therefore, the top portion of the triangular protrusion portion 33b in the slide regulation member 33 of the interlock mechanism 31 closely opposes the top portion 34a of the rotation regulation member 34, and the slide regulation member 33 is allowed to rotate about one end of the base portion 33a.

In the release state of the interlock mechanism 31, when the electromagnetic contactor 2a is brought into the close (ON) state, the movable core 8d of the electromagnetic contactor 2a is attracted by the fixed core 8c and moved. In response to this, the movable contact support 7a of the contact portion 7 is moved against the return spring 7b via the drive lever 9, and the electromagnetic contactor 2a is brought into a turned-on state.

Thus, when the electromagnetic contactor 2a is brought into the turned-on state, the movement display piece 7a1 of the contact portion 7 of the electromagnetic contactor 2a moves from an open (OFF) position shown in FIG. 4(a) to a close position shown in FIG. 4(b). Since the slide member 32a of the reversible unit 3 is connected to the movement display piece 7a1, as shown in FIG. 4(b), the slide member 32a moves from the open (OFF) position shown in FIG. 4(a) to the close position, and a left-side turned-on state is established. Consequently, the slide regulation member 33 rotates in a counterclockwise direction in which the slide regulation member 33 rotates about the engagement pin 32e of the slide member 32b, and the triangular protrusion portion 33b contacts with or closely opposes the rotation regulation wall portion 34b of the rotation regulation member 34.

In the left-side turned-on state, the triangular protrusion portion 33b of the slide regulation member 33 is in contact with or closely opposes the rotation regulation wall portion 34b of the rotation regulation member 34. Consequently, when it is intended to bring the electromagnetic contactor 2b on the right side into the close (ON) state, the slide member 32b of the interlock mechanism 31 attempts to move from the open (OFF) position shown in FIG. 4(b) to the close (ON) position on the side of the slide member 32b via the movement display piece 7a1 of the electromagnetic contactor 2b. Accordingly, although the slide regulation member 33 attempts to rotate about the engagement pin 32e of the slide member 32a in a clockwise direction, the triangular protrusion portion 33b contacts with the rotation regulation wall portion 34b of the rotation regulation member 34, and the rotation of the slide regulation member 33 is thereby prevented. As a result, when the electromagnetic contactor 2a on the left side is in the close (ON) state, the transition of the electromagnetic contactor 2b on the right side to the close (ON) is reliably prevented.

Similarly, in the state where the interlock mechanism 31 of the reversible unit 3 is in the release state as shown in FIG. 4(a), as shown in FIG. 4(c), when the electromagnetic contactor 2b on the right side is brought into the close (ON) state, the slide member 32b of the interlock mechanism 31 slides toward the slide member 32a via the movement display piece 7a1 of the electromagnetic contactor 2b. In response to this, the slide regulation member 33 rotates about the engagement pin 32e of the slide member 32a in the clockwise direction, and the triangular protrusion portion 33b comes in contact with or closely opposes the rotation regulation wall portion 34c of the rotation regulation member 34. Consequently, the rotation of the slide regulation member 33 in the counterclockwise direction is regulated, and the slide of the slide member 32a in a direction moving away from the slide member 32b is thereby regulated. Therefore, the transition of the electromagnetic contactor 2a on the left side from the open (OFF) state to the close (ON) state is reliably prevented.

Thus, in the case where the two electromagnetic contactors 2a and 2b are juxtaposed and the reversible unit 3 is attached to their arc extinguishing covers 6c, in order to connect the electromagnetic contactors 2a and 2b more firmly, a connection structure is employed in which attachment plate portions 41 formed in the lower cases 6a which attach the electromagnetic contactors 2a and 2b to a base are connected using a connection piece 42, and the electromagnetic contactors 2a and 2b are connected more firmly.

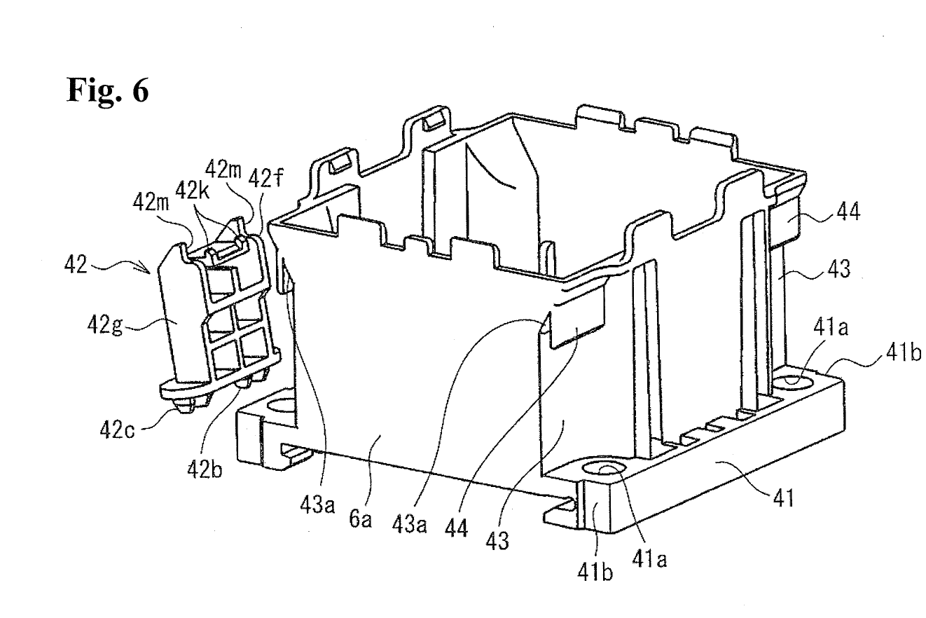

In the connection structure, as shown in FIG. 6, attachment holes 41a for inserting attachment screws (not shown) used when attaching the electromagnetic contactors 2a and 2b to the base are formed on four corners of the attachment plate portion 41 in the lower case 6a of each of the electromagnetic contactors 2a and 2b. In addition, in the attachment plate portion 41, there is formed a notch portion 41b on the side of the end portion of each attachment hole 41a in an axial direction of the electromagnet 8. Further, above each attachment hole 41a, there is formed a piece accommodation concave portion 43 which allows a tool for tightening the attachment screw inserted into the attachment hole a such as a driver or the like to be inserted thereinto, and accommodates the connection piece 42. The piece accommodation concave portion 43 is formed so as to surround the attachment hole 41a from the inside in two directions, and there is formed a locking piece 44 as a locking portion which protrudes downward on an inclined upper surface 43a of the piece accommodation concave portion 43. Furthermore, as described later, the piece accommodation concave portion 43 is formed such that, in a state where the piece accommodation concave portion 43 accommodates a half portion of the connection piece 42, the outer surface of the connection piece 42 fits within outer dimensions of the electromagnetic contactors 2a and 2b.

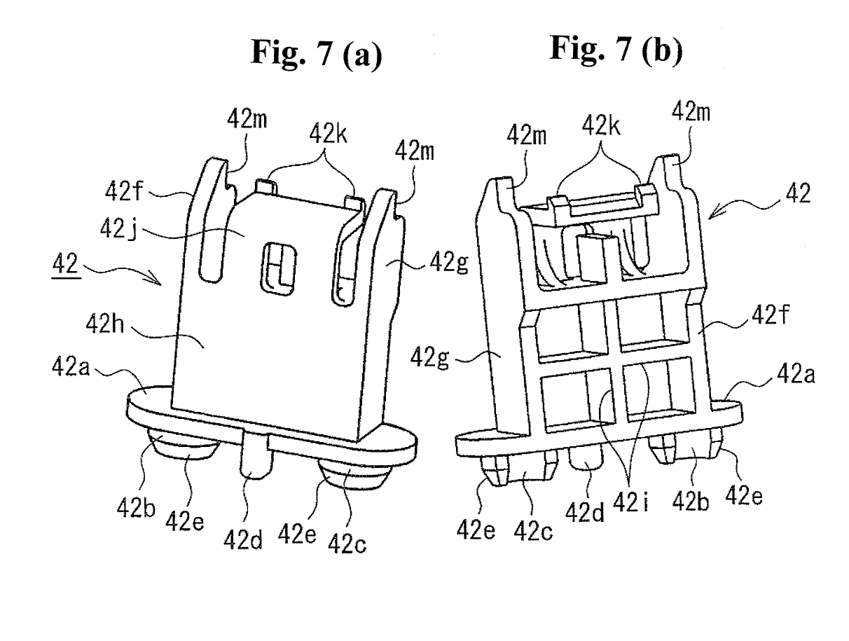

The connection piece 42 is formed by, e.g., mold forming using a synthetic resin material and, as shown in FIG. 7(a), a pair of engagement protrusions 42b and 42c to be engaged with the attachment holes 41a of the juxtaposed electromagnetic contactors 2a and 2b is formed to protrude on the lower surface side of an oblong attachment plate portion 42a. At a middle position between the engagement protrusions 42b and 42c, there is formed, e.g., a cylindrical holding protrusion 42d which forms a holding portion together with the engagement protrusions 42b and 42c. Herein, as shown in FIG. 7(b), each of the engagement protrusions 42b and 42c is formed into a C-shaped tubular shape obtained by notching its cylindrical portion on the side of the surface opposing the piece accommodation concave portion 43 of each of the electromagnetic contactors 2a and 2b, and is formed with a tapered portion 42e on the side of its lower end.

In addition, above the attachment plate portion 42a, there are formed side plate portions 42f and 42g which extend upward at positions corresponding to generally central portions of the engagement protrusions 42b and 42c, lower end sides of the side plate portions 42f and 42g are connected to each other by a front plate portion 42h, and the back surface side of the front plate portion 42h is formed with lattice-like frame portions 42i, whereby the mechanical strength is secured.

On the upper end side of each of the side plate portions 42f and 42g, there is formed a curve portion 42j which extends upward from the upper end of the front plate portion 42h and then extends backward toward the piece accommodation concave portion 43 of each of the electromagnetic contactors 2a and 2b. At the tip of the curve portion 42j, there are formed hook portions 42k which slightly protrude upward and serve as a pair of locked portions to be locked inside the above-described locking piece 44 formed in the upper portion of the piece accommodation concave portion 43. Further, at the tip portions of the side plate portions 42f and 42g, there are formed engagement portions 42m which are engaged with the front sides of the locking pieces 44.

Next, a description is given of the operation of the above-described embodiment.

In order to attach the reversible unit 3 to the pair of electromagnetic contactors 2a and 2b, as shown in FIG. 5, in the state where the pair of electromagnetic contactors 2a and 2b is juxtaposed in the same direction, mutual side walls are firstly brought into contact with each other. In this state, the electromagnet 8 of each of the electromagnetic contactors 2a and 2b is in a non-energized state, and the movable contact support 7a of the contact portion 7 is pressed by the return spring 7b and each of the electromagnetic contactors 2a and 2b is maintained to be in the open (OFF) state. Consequently, as shown in FIG. 5, each of the movement display pieces 7a1 of the electromagnetic contactors 2a and 2b indicates the open position on the right side.

Subsequently, in a state where the reversible unit 3 is set such that the movement display pieces 36a and 36b are at the open positions on the right side, the snap pieces 3c and 3d and the snap pieces 3e and 3f of the reversible unit 3 are caused to oppose the connection holes 12 and 13 formed in the arc extinguishing cover 6c of the electromagnetic contactor 2a and the connection holes 12 and 13 formed in the arc extinguishing cover 6c of the electromagnetic contactor 2b, respectively.

In this state, the reversible unit 3 is pushed down toward the electromagnetic contactors 2a and 2b, whereby the snap pieces 3c and 3d and the snap pieces 3e and 3f are inserted into the connection holes 12 and 13 of the electromagnetic contactors 2a and 2b and locked, and the display piece engagement portions 38a and 38b of the reversible unit 3 are engaged with the movement display pieces 7a1 of the electromagnetic contactors 2a and 2b.

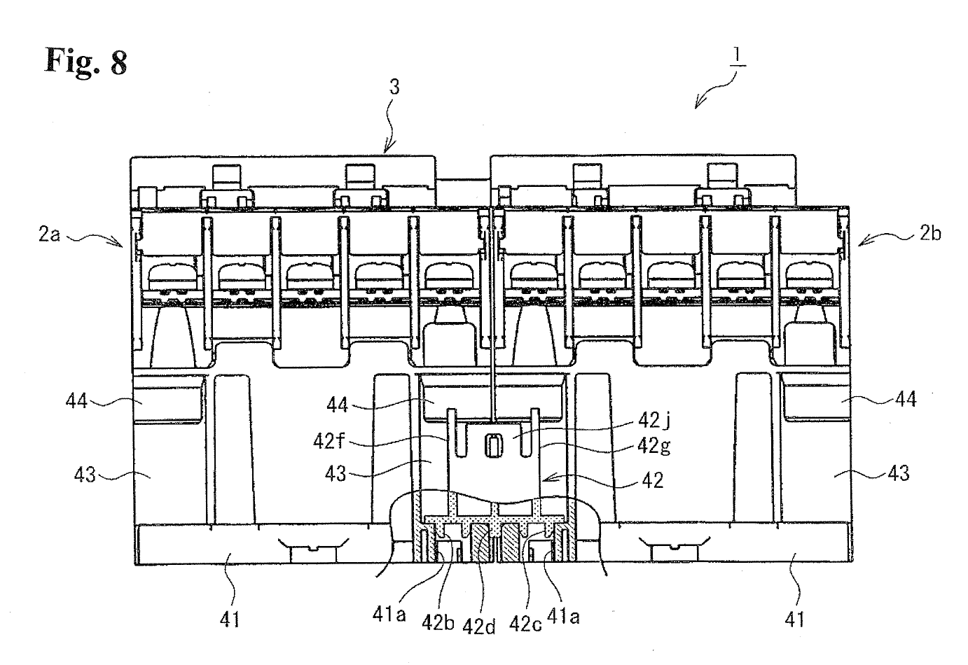

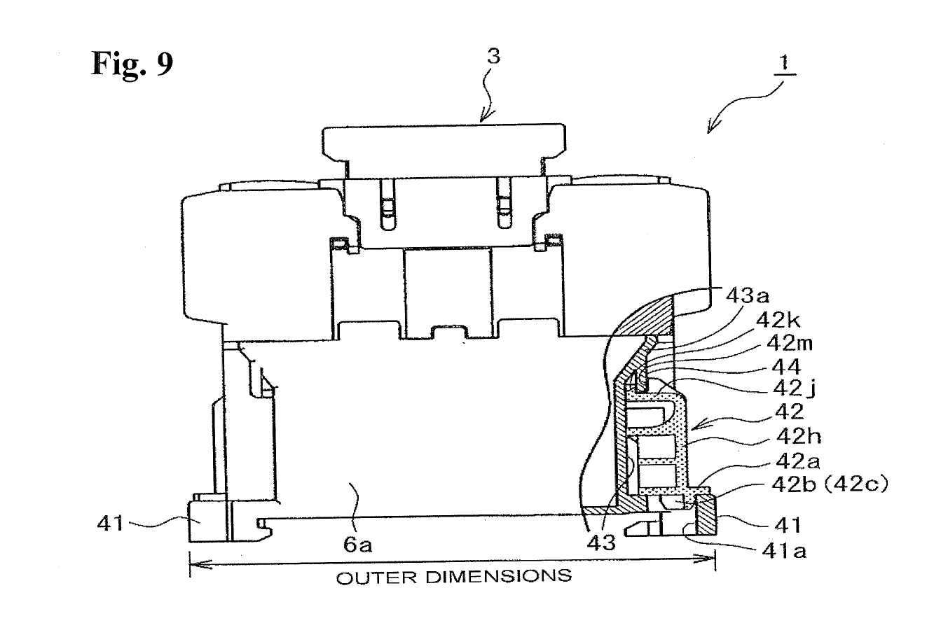

Subsequently or before the reversible unit 3 is attached, the attachment plate portions 41 at the connection positions of the electromagnetic contactors 2a and 2b are connected using the two connection pieces 42 disposed at the front and the rear. In the connection using the connection piece 42, as shown in FIGS. 8 and 9, in a state where the back side of the connection piece 42 is firstly faced toward the side of the piece accommodation concave portion 43, while the engagement protrusions 42b and 42c and the holding protrusion 42d formed on the lower surface side of the connection piece 42 are engaged with the attachment holes 41a of the electromagnetic contactors 2a and 2b, the holding protrusion 42d is inserted between the notch portions 41b formed in the attachment plate portions 41 of the electromagnetic contactors 2a and 2b. With this, the holding protrusion 42d and the engagement protrusions 42b and 42c hold portions between the attachment holes 41a and the notch portions 41b in the attachment plate portions 41 of the electromagnetic contactors 2a and 2b therebetween. At this point, since each of the engagement protrusions 42b and 42c of the connection piece 42 is formed into the C-shaped tubular portion, each of the engagement protrusions 42b and 42c can bend, and since the tip of each of the engagement protrusions 42b and 42c is formed with the tapered portion 42e, it is possible to easily perform the engagement with the attachment hole 41a.

Subsequently, the curve portion 42j of the connection piece 42 is bent, the hook portions 42k are inserted into the back sides of the locking pieces 44 formed in the upper portions of the piece accommodation concave portions 43 of the electromagnetic contactors 2a and 2b, and the engagement portions 42m at the tips of the side plate portions 42f and 42g are engaged with the front sides of the locking pieces 44 to release the bending of the curve portion 42j, whereby the locking pieces 44 are held between and fixed by the hook portions 42k and the engagement portions 42m.

Thus, by firmly connecting the sides of the attachment plate portions 41 of the electromagnetic contactors 2a and 2b using the two connection pieces 42, it is possible to adequately resist an external force in an X direction shown in FIG. 1 which is a direction moving the electromagnetic contactors 2a or 2b away from the connection surface by the individual engagement of the engagement protrusions 42b and 42c with the attachment holes 41a of the electromagnetic contactors 2a and 2b.

In addition, when an external force in a Y direction which displaces the electromagnetic contactors 2a and 2b in mutually opposite directions acts, the engagement protrusions 42b and 42c of the connection piece 42 are engaged with the attachment holes 41a of the attachment plate portions 41 of the electromagnetic contactors 2a and 2b, and the hook portions 42k serving as the locked portions and the engagement portions 42m of the side plate portions 42f and 42g hold the locking pieces 44 formed in the upper portions of the piece accommodation concave portions 43 therebetween, whereby it is possible to adequately resist the external force.

Further, when an external force in a Z direction which displaces the electromagnetic contactors 2a and 2b in mutually opposite directions acts, the attachment plate portion 42a formed with the engagement protrusions 42b and 42c contacts with the attachment plate portion 41 in one electromagnetic contactor 2a (or 2b), and the engagement portions 42m of the side plate portions 42f and 42g contact with the locking piece 44 in the other electromagnetic contactor 2b (or 2a). Consequently, it is possible to adequately resist the external force which displaces the electromagnetic contactors 2a and 2b in mutually opposite directions. Also, when an external force in a twisting direction acts on the electromagnetic contactors 2a and 2b, similarly to the above-described cases, it is possible to adequately resist the external force.

Note that, in order to separate the connected electromagnetic contactors 2a and 2b from each other, in a state where the reversible unit 3 is detached and the hook portions 42k are removed from the back surfaces of the locking pieces 44 formed in the upper portions of the piece accommodation concave portions 43 by bending the curve portion 42j of the connection piece 42 downward, the connection piece 42 is rotated so as to be moved away from the piece accommodation concave portions 43, and it is thereby possible to easily separate the connection piece 42 from the piece accommodation concave portions 43.

In addition, since the reversible unit 3 is attached to the upper surfaces of the electromagnetic contactors 2a and 2b on the side opposite to the side of the connection piece 42, it is possible to connect the electromagnetic contactors 2a and 2b to each other and hold them more firmly.

Further, since the connection piece can be formed by integral molding such as mold forming or the like, it is possible to easily manufacture the connection piece.

Furthermore, since the concave portion for inserting a tool for tightening an attachment screw inserted into the attachment hole 41a such as a driver or the like is utilized as the piece accommodation concave portion 43 of each of the electromagnetic contactors 2a and 2b, it is possible to manufacture the electromagnetic contactor unit without significantly modifying the existing electromagnetic contactors 2a and 2b, and the strength in the lower case 6a is not reduced.

Note that, in the above-described embodiment, the description has been given of the case where the holding protrusion 42d formed between the engagement protrusions 42b and 42c of the connection piece 42 is cylindrical. However, the present invention is not limited thereto, and the holding protrusion 42d can be formed into a plate-like shape, or a conical or wedge-like shape which is tapered toward the lower end thereof. In addition, the holding protrusion 42d can also be omitted.

Moreover, in the above-described embodiment, the description has been given of the case where the curve portion 42j and the hook portions 42k are provided as the locked portions. However, the present invention is not limited thereto, and the hook portions 42k may be adapted to be vertically slidable, and the hook portions 42k may be biased upward using an elastic body such as a spring or the like.

Additionally, the formation position of the locking piece 44 formed in the piece accommodation concave portion 43 of each of the electromagnetic contactors 2a and 2b is not limited to the upper portion side of the piece accommodation concave portion 43, and the locking piece 44 may also be formed inside the piece accommodation concave portion 43 (side surface in the Y direction). In this case, the locked portions may be formed in left and right side portions of the connection piece 42, and the upper surface of the connection piece 42 may be brought into contact with the upper surface of the piece accommodation concave portion 43.

### INDUSTRIAL APPLICABILITY

According to the present invention, it is possible to provide an electromagnetic contactor unit capable of firmly connecting electromagnetic contactors without influencing outer dimensions when the electromagnetic contactors are connected to each other.

### EXPLANATION OF REFERENCE NUMERALS

2a, 2b . . . electromagnetic contactor, 3 . . . reversible unit, 3a . . . unit main body, 3b . . . contactor attachment portion, 3c to 3f . . . snap piece, 3g . . . unit attachment portion, 3h to 3m . . . connection hole, 6 . . . main body case, 6a . . . lower case, 6b . . . upper case, 6c . . . arc extinguishing cover, 6c1 lever support portion, 6c2 display window, 6e . . . contactor-side attachment allowance portion, 6f . . . contactor-side attachment prevention portion, 7 . . . contact portion, 7a . . . movable contact support, 7a1 . . . movement display piece, 7b . . . return spring, 7c . . . movable contact, 8 . . . electromagnet, 8a . . . coil, 8b . . . coil frame, 8c . . . fixed core, 8d . . . movable core, 9 . . . drive lever, 10 . . . terminal portion, 11 . . . coil terminal portion, 12 to 15 . . . connection hole, 31 . . . interlock mechanism, 32a, 32b . . . slide member, 33 . . . slide regulation member, 34 . . . rotation regulation member, 36a, 36b . . . movement display piece, 41 . . . attachment plate portion, 41a . . . attachment hole, 42 . . . connection piece, 42a . . . attachment plate portion, 42b, 42c . . . engagement protrusion, 42d . . . . . . . . . holding protrusion, 42f, 42g . . . side plate portion, 42j . . . curve portion, 42k . . . hook portion, 42m . . . engagement portion, 43 . . . piece accommodation concave portion, 44 . . . locking piece

1. An electromagnetic contactor unit wherein at least two juxtaposed electromagnetic contactors is connected with a connection piece,
wherein each of the electromagnetic contactors comprises
an attachment hole formed in each corner of an attachment plate portion,
a piece accommodation concave portion fitting a half portion of the connection piece, formed above the attachment hole and accommodating within an outer dimension thereof, said piece accommodating concave portion opening to a connection surface with the adjacent electromagnetic contactor, and
a locking portion locking the connection piece, formed in the piece accommodation concave portion, and
the connection piece includes a pair of engagement protrusions individually engaging the adjacent attachment holes of the juxtaposed electromagnetic contactors, and a locked portion locked by the locking portion.

2. An electromagnetic contactor unit according to claim 1, wherein the connection piece at least comprises:
a connection plate portion formed with the pair of engagement protrusions on one surface,
a pair of side plate portions formed on the other surface of the connection plate portion,
a front plate portion connecting connection plate portion sides of the pair of side plate portions, and
a curve portion curved from a tip of the front plate portion to a rearward side and having the locked portion formed to protrude at the tip.

3. A n electromagnetic contactor unit according to claim 1, wherein the piece accommodation concave portion is a concave portion formed for allowing an insertion of a tool for tightening a screw inserted into the attachment hole.

4. An electromagnetic contactor unit according to claim 1, wherein a holding protrusion is formed between the pair of engagement protrusions of the connection piece such that the holding protrusion serves as a holding portion by cooperating with the pair of engagement protrusions when inserted between the adjacent electromagnetic contactors.

5. An electromagnetic contactor unit according to claim 1, wherein each of the pair of engagement protrusions is formed into a C-shaped tubular shape formed by notching a cylindrical portion thereof on a side of a contact surface with the piece accommodation portion, and has a tapered portion formed on an outer peripheral surface of a tip side thereof.

6. An electromagnetic contactor unit according to claim 3, wherein a holding protrusion is formed between the pair of engagement protrusions of the connection piece such that the holding protrusion serves as a holding portion by cooperating with the pair of engagement protrusions when inserted between the adjacent electromagnetic contactors.

7. An electromagnetic contactor unit according to claim 3, wherein each of the pair of engagement protrusions is formed into a C-shaped tubular shape formed by notching a cylindrical portion thereof on a side of a contact surface with the piece accommodation portion, and has a tapered portion formed on an outer peripheral surface on a tip side thereof.

8. An electromagnetic contactor unit according to claim 3, wherein a holding protrusion is formed between the pair of engagement protrusions of the connection piece such that the holding protrusion serves as a holding portion by cooperating with the pair of engagement protrusions when inserted between the adjacent electromagnetic contactors, and
each of the pair of engagement protrusions is formed into a C-shaped tubular shape formed by notching a cylindrical portion thereof on a side of a contact surface with the piece accommodation portion, and has a tapered portion formed on an outer peripheral surface on a tip side thereof.
